(19) United States
(12) Patent Application Publication
(10) Pub. No.: US 2026/0230688 A1
(43) Pub. Date: Aug. 6, 2026

(54) VIDEO PROCESSING DEVICE, VIDEO PROCESSING METHOD, AND RECORDING MEDIUM HAVING VIDEO PROCESSING PROGRAM STORED THEREIN

(71) Applicant: NEC Corporation, Tokyo (JP)

(72) Inventor: Kazuya KAWAKAMI, Tokyo (JP)

(73) Assignee: NEC Corporation, Tokyo (JP)

(21) Appl. No.: 19/150,220

(22) PCT Filed: Dec. 28, 2023
(86) PCT No.: PCT/JP2023/047142

§ 371 Date: Jul. 23, 2025

(30) Foreign Application Priority Data
Jan. 30, 2023 (JP) 2023-012299

(51) Int. Cl. H04N 21/8549; G06V 20/40

(52) U.S. Cl. CPC H04N 21/8549; G06V 20/44

(57) ABSTRACT

A video processing device 30 comprises a video acquisition unit 31 which acquires a video 310, an event information acquisition unit 32 which acquires information 320 indicative of a time point when an event was detected, and a generation unit 33 which, on the basis of the video 310 and the information 320 indicative of the time point when the event was detected, generates a summary video 333 that includes a period from a time point when an event satisfying a first condition 331 was detected until a time point when an event satisfying a second condition 332 was detected.

### TECHNICAL FIELD

The present invention relates to a video processing device, a video processing method, and a video processing program.

### BACKGROUND ART

In the police, evidence videos necessary for identification of an indictment of a suspect of a crime or the like are created from videos captured by a body worn camera (BWC) worn by a police officer, a police in-vehicle camera, or the like. An insurance company creates an evidence video necessary for recognition of an accident or the like from a video captured by an in-vehicle camera of an accident vehicle, an in-vehicle camera installed on a road or the like, or the like. In order to efficiently create (edit) such an evidence video, a technology for supporting creation work of the evidence video is expected.

In relation to the above-described technology, PTL 1 discloses an information processing device that supports creation of documents and video data related to an incident in police. This device acquires a video specified in a terminal device from a storage device that stores a video captured by a wearable camera worn or possessed by a police officer or an in-vehicle camera mounted on a police vehicle. Then, the device analyzes the video to generate meta information, and generates a summary video file from which the video to be reported is extracted.

PTL 2 discloses an information processing system that extracts each scene included in a video in a suitable manner. This system generates meta information including information on a section corresponding to a plurality of consecutive frames in a time series of at least a part of a series of frames constituting a video, and a keyword. The system associates the generated meta information with the video, and searches the meta information including the keyword satisfying the specified condition from one or more pieces of meta information associated with the video. The system extracts a plurality of frames corresponding to the section from the video based on the information about the section included in the searched meta information.

### CITATION LIST

### Patent Literature

PTL 1: JP 2020-005014 A
PTL 2: JP 2022-076119 A

### SUMMARY OF INVENTION

### Technical Problem

In PTL 1 and PTL 2 described above, a video including a section including meta information is extracted. However, only summarizing the video based on the meta information may result in insufficient information. Alternatively, there is a possibility that a summary video including information more than necessary is generated.

A main object of the present invention is to generate a summary video composed of an appropriate period of time.

### Solution to Problem

A video processing device according to an aspect of the present invention includes: a video acquisition means for acquiring a first video; an event information acquisition means for acquiring information indicating a time at which an event is detected; and a generation means for generating, based on the first video and information indicating a time at which the event is detected, a first summary video including a period from a time at which an event satisfying a first condition is detected to a time at which an event satisfying a second condition is detected.

In another viewpoint of achieving the above object, a video processing method according to an aspect of the present invention causes an information processing device to execute: acquiring a first video; acquiring information indicating a time at which an event is detected; and generating a first summary video including a period from a time at which an event satisfying a first condition is detected to a time at which an event satisfying a second condition is detected based on the first video and information indicating a time at which the event is detected.

From a further viewpoint of achieving the above object, a video processing program according to an aspect of the present invention causes a computer to execute: a video acquisition process of acquiring a first video; a time acquisition process of acquiring information indicating a time at which an event is detected; and a generation process of generating, based on the first video and information indicating a time at which the event is detected, a first summary video including a period from a time at which an event satisfying a first condition is detected to a time at which an event satisfying a second condition is detected.

Furthermore, the present invention can also be implemented by a computer-readable non-volatile recording medium storing the video processing program (computer program).

### Advantageous Effects of Invention

The present invention can generate a summary video composed of appropriate time periods.

### BRIEF DESCRIPTION OF DRAWINGS

FIG. 1 is a block diagram illustrating a configuration of a video processing system 1 according to a first example embodiment of the present invention.

FIG. 2 is a diagram illustrating a first example in which a video processing device 10 according to the first example embodiment of the present invention generates a summary video 167 from an acquired video 161.

FIG. 3 is a diagram illustrating a second example in which the video processing device 10 according to the first example embodiment of the present invention generates the summary video 167 from the acquired video 161.

FIG. 4 is a diagram illustrating a third example in which the video processing device 10 according to the first example embodiment of the present invention generates the summary video 167 from the acquired video 161.

FIG. 5 is a diagram illustrating a display mode in which the video processing device 10 according to the first example embodiment of the present invention displays the generated the summary video 167 on a terminal device 23.

FIG. 6A is a flowchart (1/2) illustrating the operation of the video processing device 10 according to the first example embodiment of the present invention.

FIG. 6B is a flowchart (2/2) illustrating the operation of the video processing device 10 according to the first example embodiment of the present invention.

FIG. 7 is a block diagram illustrating a configuration of a video processing device 30 according to a second example embodiment of the present invention.

FIG. 8 is a flowchart illustrating an operation of the video processing device 30 according to the second example embodiment of the present invention.

FIG. 9 is a block diagram illustrating a configuration of an information processing device 900 capable of realizing the video processing device according to each example embodiment of the present invention.

### EXAMPLE EMBODIMENT

Hereinafter, example embodiments of the present invention will be described in detail with reference to the drawings.

### First Example Embodiment

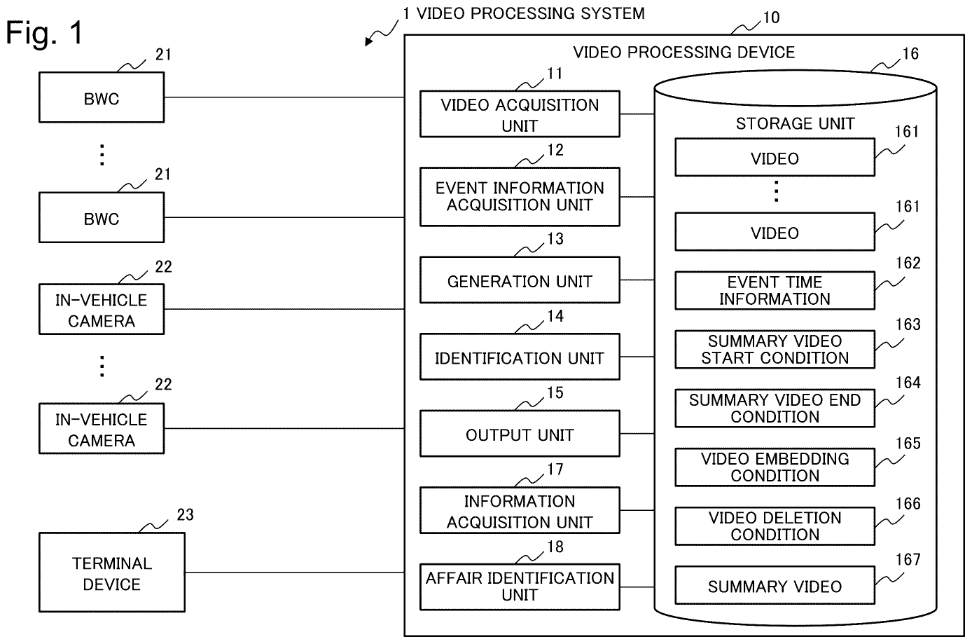

FIG. 1 is a block diagram illustrating a configuration of a video processing system 1 according to a first example embodiment of the present invention. The video processing system 1 is a system that generates an evidence video used for a suit or the like regarding an affair (incident or accident) corresponding to the police.

The video processing system 1 roughly includes a video processing device 10, one or more BWCs 21, one or more in-vehicle cameras 22, and a terminal device 23. The BWC 21 is worn by individual police officers and continuously captures videos during work. The in-vehicle camera 22 is mounted on a police vehicle, and continuously captures a video while the police vehicle is in operation. The present invention is not limited to the above, and the BWC 21 may be one in which imaging is temporarily interrupted during working. Imaging may be started from the middle of work. Even when the police vehicle is in operation, the imaging of the in-vehicle camera 22 may be temporarily interrupted. The imaging may be started after a predetermined time has elapsed since the operation of the police vehicle. In addition to or in place of the BWC 21 and the in-vehicle camera 22, the video processing system 1 may use a wearable camera, a smartphone camera, a surveillance camera installed in a town, a camera mounted on a drone, or the like (not illustrated). Furthermore, only one of them may be used. In the present example embodiment, the BWC 21, the in-vehicle camera 22, a smartphone camera, a surveillance camera installed in a town, a camera mounted on a drone, and the like may be collectively referred to as imaging device.

The imaging device may be communicably connected to video processing device 10, and transmit a captured video 161 to the video processing device 10. In this case, from the viewpoint of preventing information leakage, the communication line connecting the imaging device and the video processing device 10 may be a dedicated line. Alternatively, the imaging device may not be communicably connected to the video processing device 10, and the captured video 161 may be input to the video processing device 10 via a recording medium such as a memory card.

The terminal device 23 is, for example, an information processing device such as a personal computer, a tablet terminal, or a smartphone, and is communicably connected to the video processing device 10. The terminal device 23 has a user interface function used when a police officer inputs information to the video processing device 10 or confirms information output from the video processing device 10.

The video processing device 10 includes a video acquisition unit 11, an event information acquisition unit 12, a generation unit 13, an identification unit 14, an output unit 15, a storage unit 16, an information acquisition unit 17, and an affair identification unit 18. The video acquisition unit 11, the event information acquisition unit 12, the generation unit 13, the identification unit 14, and the affair identification unit 18 are examples of a video acquisition means, an event information acquisition means, a generation means, an identification means, and an affair identification means in order.

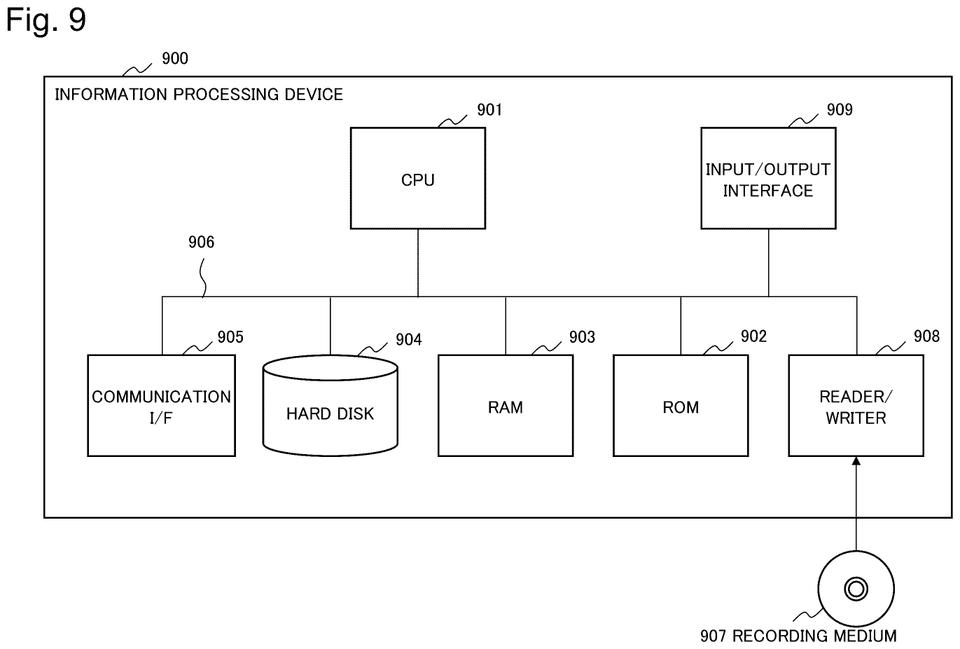

The storage unit 16 is, for example, a storage device such as a random access memory (RAM) 903 or a hard disk 904 described later with reference to FIG. 9. The storage unit 16 stores a video 161, event time information 162, a summary video start condition 163, a summary video end condition 164, a video embedding condition 165, a video deletion condition 166, and a summary video 167. These pieces of information stored in the storage unit 16 will be described later.

The video acquisition unit 11 acquires the video 161 captured by the BWC 21 and the video 161 captured by the in-vehicle camera 22. The video acquisition unit 11 may acquire these videos 161 (the first video and the second video) via a communication line (communication network) communicably connecting the BWC 21, the in-vehicle camera 22, and the video processing device 10, or via a recording medium such as a memory card on which the video 161 is recorded.

The video 161 is a video obtained by imaging the periphery of a police officer who is in operation, and includes, for example, a video obtained when the police officer heads to the scene of an affair in response to an emergency call to the police, a video obtained when an investigation is performed at the scene or the like, a video obtained when an affair is watched, a video obtained when a suspect of a crime is secured, and the like. The video 161 includes voice and imaging time (time record).

The video acquisition unit 11 stores the individual videos 161 captured by the BWC 21 and the in-vehicle camera 22 in the storage unit 16 in association with information that can identify an affair to be investigated. As the information that can identify the affair to be investigated, for example, identification information of an affair that is included in the work management information of each police officer and that is being investigated by each police officer for each time zone can be used. The video acquisition unit 11 associates each individual video 161 with the identification information of the affair based on the identification information of the BWC 21 used by the police officer in charge of the affair, the identification information of the in-vehicle camera 22 mounted on the police vehicle used (boarded) by the police officer, and the work management information of each police officer.

The information acquisition unit 17 separately acquires information (image, text, etc.) posted on a social networking service (SNS) or the like. For example, the information acquisition unit 17 may acquire the information regarding the affair from the SNS or the like using a keyword regarding the affair. The keyword is indicated by, for example, an analysis result of the video 161 by the event information acquisition unit 12 described later. The information acquisition unit 17 stores the information acquired from the SNS or the like in the storage unit 16.

The event information acquisition unit 12 acquires the event time information 162 indicating the time when an event (happening) related to the affair has been detected. The event information acquisition unit 12 also acquires the type of the event. The event information acquisition unit 12 may acquire, for example, information indicating an investigation result regarding the affair as the event time information 162. The information indicating the investigation result regarding the affair is obtained by the police officer inputting the information using the terminal device 23. The information indicating the investigation result includes the time when each event is detected as information indicating the time series of the event. Alternatively, the event information acquisition unit 12 may acquire information indicating an operation (driving) history of the police vehicle, a communication history of the police radio, and the like as the event time information 162.

The event information acquisition unit 12 analyzes the video 161 acquired by the video acquisition unit 11, and detects an event based on at least one of the information regarding the sound included in the video 161 and the information regarding the movement of the object (person or thing). Then, a time at which the detected event has occurred is specified. The time at which the event has occurred is the time at which the event has started, the time at which the event has ended, or the like. Alternatively, it may be a time between a time when the event has started and a time when the event has ended. In this manner, the time at which the event has occurred may be used as the event time information 162.

More specifically, the event information acquisition unit 12 includes a voice analysis unit, an image analysis unit, and an action detection unit in order to perform the above-described processing. The voice analysis unit, the image analysis unit, and the action detection unit may be provided other than the event information acquisition unit 12. For example, in the video processing device 10 including the event information acquisition unit 12, these units may be separately configured from the event information acquisition unit 12, or may be provided in a device different from the video processing device 10.

The voice analysis unit of the event information acquisition unit 12 analyzes the voice included in the video 161 using an existing voice recognition technology. The voice included in the video 161 includes a sound generated from an object and an utterance by a person. The sound generated from the object includes, for example, a sound (engine sound, sound generated when brake is applied, klaxon horn, siren, and the like) generated from the vehicle when the vehicle is operated, a gunshot, a sound (sound, footsteps, and the like generated when persons or things collide with each other when a plurality of persons are at a battle) generated with the movement of the person, a scream of the person, and the like.

The voice analysis unit of the event information acquisition unit 12 performs voice recognition processing on the voice representing the utterance of the person to generate text representing the utterance of the person, and performs existing natural language processing (morphological analysis, syntax analysis, etc.) on the text to analyze the content of the utterance. The voice analysis unit of the event information acquisition unit 12 may extract a keyword typical of the affair included in the utterance from the analysis result of the content of the utterance.

The voice analysis unit of the event information acquisition unit 12 specifies the time at which the event related to the affair is detected from the result of analyzing the voice included in the video 161 as described above. The voice analysis unit of the event information acquisition unit 12 specifies, for example, the time when a voice such as “catch a thief” has been uttered by a certain person (victim) as the time when the event of the crime has been detected. The voice analysis unit of the event information acquisition unit 12 specifies, for example, the time when a voice such as “a suspect escapes on a black vehicle” has been uttered by a police officer as the time when the event that the suspect escapes from the crime scene has been detected. The voice analysis unit of the event information acquisition unit 12 specifies, for example, the time at which a voice such as “a suspect has been caught at 22:53 on December 10” is uttered by a police officer as the time at which the event in which the suspect is caught has been detected.

The image analysis unit of the event information acquisition unit 12 also analyzes the video 161 using an existing image recognition technology. The image recognition technology includes a face detection technology, a face authentication technology, an object detection technology, an action detection technology, and the like. For example, the image analysis unit of the event information acquisition unit 12 detects a face of a person included in the video 161 using the face detection technology, and determines whether the face of the detected person is registered in a database of a criminal (person with previous criminal record) using the face authentication technology.

The image analysis unit of the event information acquisition unit 12 determines what is included in the video 161 by using the object detection technology, and detects, for example, that a thing possessed by a person is a weapon such as a gun or a knife. The image analysis unit of the event information acquisition unit 12 may detect the vehicle included in the video 161 using the object detection technology and determine the vehicle type of the vehicle from the shape of the vehicle.

The action detection unit of the event information acquisition unit 12 also detects the type of action of the person included in the video 161 using the action detection technology. The action detection unit of the event information acquisition unit 12 detects, for example, an action in which a suspect included in the video 161 attacks a victim or a police officer, an action in which the suspect runs from a crime scene or escapes by driving a vehicle, an action in which a police officer collapses to the ground together with the suspect and secures the suspect, and the like.

In a case where the suspect escapes by driving the vehicle, the action detection unit of the event information acquisition unit 12 may identify the escape route of the suspect from the result of tracking the vehicle included in the video 161 by recognizing the license plate of the vehicle included in the video 161.

In the analysis of the video 161 described above, the image analysis unit of the event information acquisition unit 12 may specify a person whose face does not appear by face authentication by specifying that a person whose face does not appear at a certain time and a person whose face appears at times before and after the certain time are the same person from features such as clothes.

The event information acquisition unit 12 specifies the time at which the event related to the affair is detected from the result of analyzing the video 161 as described above. For example, the event information acquisition unit 12 specifies a time when a certain person (suspect) attacks another person (victim) and then the victim falls onto the ground as a time when an event in which a crime has occurred is detected. For example, the event information acquisition unit 12 specifies the time when the suspect has escaped when the police officer tried to secure the suspect as the time when the event that the suspect has escaped from the crime scene is detected. For example, the event information acquisition unit 12 specifies the time when the police officer collapses to the ground together with the suspect and secures the suspect as the time when the event in which the suspect is secured is detected.

The event information acquisition unit 12 may also combine the analysis result of the voice included in the video 161 and the analysis result of the video 161 to specify the time at which the event related to the affair is detected. For example, the event information acquisition unit 12 specifies the time when the victim falls to the ground after the gunshot as the time when the event in which the crime has occurred is detected.

The event information acquisition unit 12 stores the event time information 162 representing the time at which the event acquired (specified) by the above-described processing is detected in the storage unit 16 in association with the video 161.

The affair identification unit 18 specifies the type of the affair represented by the video 161 from the result of the above-described analysis processing by the event information acquisition unit 12 for the acquired video 161. Then, the identification unit 14 specifies the video embedding condition 165 (third condition) based on the type of the affair specified by the affair identification unit 18.

The type of the affair includes an incident and an accident. In a case where the affair is an incident, the type of the affair includes, for example, homicide, injury, burglary, theft, instrument damage, extortion, and fraud. In a case where the affair is an accident, the type of the affair includes, for example, a single accident of a vehicle, a collision accident between vehicles, a collision accident between a vehicle and a pedestrian, a collision accident between a railway and a vehicle, a collision accident between a railway and a pedestrian, and the like. In the storage unit 16, the video embedding condition 165 for each type of these affairs is stored in advance by, for example, an administrator or the like of the video processing device 10.

For example, in a case where the video 161 represents a situation in which an instrument is damaged by a certain person (suspect), the affair identification unit 18 specifies the type of the affair represented by the video 161 as instrument damage. For example, in a case where the video 161 indicates a situation in which a certain person (suspect) is beating another person (victim), the affair identification unit 18 specifies the type of the affair indicated by the video 161 as an injury or a homicide (in a case where the victim dies). The affair identification unit 18 may specify the type of the affair as described above using, for example, artificial intelligence (AI) that has learned the relationship between the analysis result of the video 161 and the type of the affair represented by the video 161.

The video embedding condition 165 is a condition used when the generation unit 13 to be described later determines whether a certain portion (scene) included in the video 161 is included in the summary video 167. The video embedding condition 165 represents a check point (evaluation list) for each type of affair that needs to be confirmed when the police investigate the affair. The check point is, for example, a point to be included in a record created by the police as an investigation result of an affair, and is a point to be desirably included in an evidence video.

The check points include, for example, date and place of occurrence of the affair, information (attributes and the like) on the victim, information (attribute, content of previous criminal record, etc.) on the suspect, information on a method by which the suspect attacked the victim and members (gun, blade, etc.) used at that time, information on a stolen thing, information on an escape route of the suspect, and the like.

Based on the video 161 and the information regarding the type of the event or the event time information 162 acquired by the event information acquisition unit 12, the generation unit 13 generates the summary video 167 (first and second summary videos) representing at least a part of the video 161 including a period from a time when an event satisfying the summary video start condition 163 (first condition) is detected to a time when an event satisfying the summary video end condition 164 (second condition) is detected. The summary video 167 represents an evidence video of a target affair. The summary video start condition 163 and the summary video end condition 164 are set in advance by, for example, an administrator or the like of the video processing device 10.

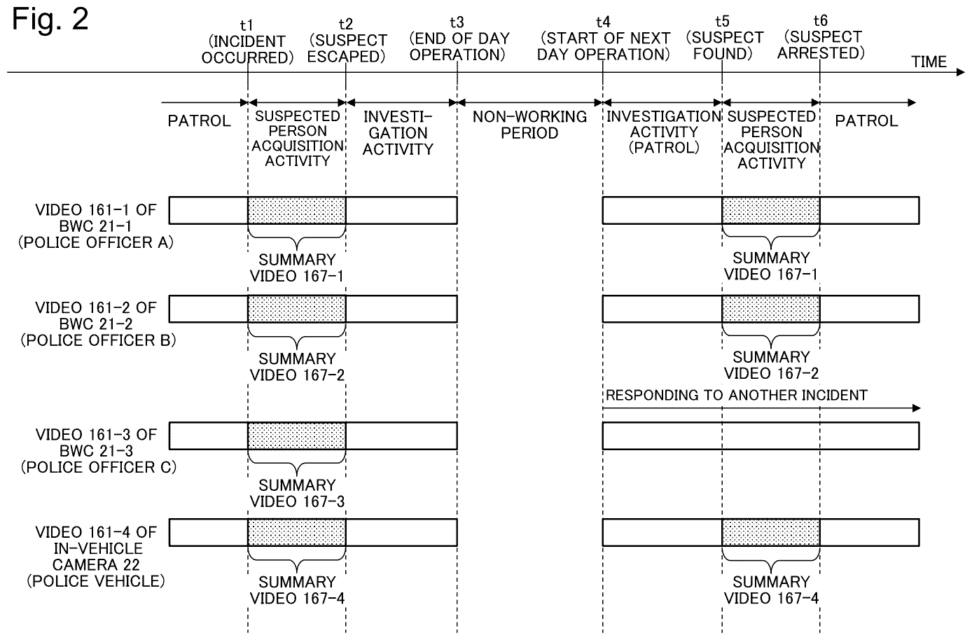

FIG. 2 is a diagram illustrating a first example in which the generation unit 13 according to the present example embodiment generates the summary video 167 to be used as evidence video based on the video 161 and the information indicating the time when the event is detected.

FIG. 2 illustrates a case of an incident where the police encountering the incident (having watched the incident) fails in securing the suspect and the suspect escapes, and then the suspect is secured in the investigation on the next day.

In the example shown in FIG. 2, the police encounters the incident at time t1 during patrol, and carries out an activity of securing a suspect (activity of securing a suspect), but the suspect escapes at time t2 after time t1. The police then performs an investigation activity of the incident, and ends the day's work at time t3 after time t2. At time t4 after time t3, the police starts the next day's work and starts an investigation (patrol) of the incident. At time t5 after time t4, the police finds a suspect who could not be secured yesterday, conducts an activity of securing a person of the suspect, arrests the suspect at time t6 after time t5, and then resumes patrol.

In the example illustrated in FIG. 2, the video processing device 10 uses four videos 161-1 to 161-4 as original data used for generating the summary video 167 used as evidence videos related to the incident. In the present example embodiment, the plurality of videos 161 and the BWCs 21 are separately described as, for example, videos 161-1 and BWCs 21-1. The video 161-1 is a video captured by the BWC 21-1 worn on a police officer A. The video 161-2 is a video captured by the BWC 21-2 worn on a police officer B. The video 161-3 is a video captured by the BWC 21-3 worn on a police officer C. The video 161-4 is a video captured by the in-vehicle camera 22 mounted on a police vehicle on which the police officers A to C get on to respond to the incident.

In the example illustrated in FIG. 2, the event time information 162 acquired (generated) by the event information acquisition unit 12 as described above indicates that the incident occurs at time t1, the suspect escapes at time t2, the suspect is found at time t5, and the suspect is arrested at time t6. The videos 161-1 to 161-4 are not captured in a period from time t3 to time t4 which is a non-work period.

The generation unit 13 specifies the time at which an event satisfying the summary video start condition 163 is detected in the event time information 162 as the start time of the summary video 167. The summary video start condition 163 is, for example, that an event capable of specifying that an incident or an accident has occurred is detected. Examples of the event that can be identified as the occurrence of an incident or an accident include a case where terms such as “occurrence” and “dispatch” are extracted together with terms related to the incident or the accident from voice. Alternatively, it is a case where it is detected from the video that an affair has occurred. According to the example illustrated in FIG. 2, the police officer A grasps that the incident has occurred at time t1. Accordingly, the generation unit 13 specifies that the occurrence time of the event satisfying the summary video start condition 163 is time t1. Consequently, in the video 161-1, time t1 is specified as the start time of the summary video 167. The summary video start condition 163 may be a condition different from the occurrence of the incident. For example, in a case where the video 161 by a monitoring camera or the like indicating suspicious action of the suspect before the suspect causes the incident is obtained by chance, the summary video start condition 163 may be a time at which the suspicious action of the suspect is first imaged.

The generation unit 13 specifies the time at which an event satisfying the summary video end condition 164 is detected in the event time information 162 as the end time of the summary video 167. The summary video end condition 164 is that an event capable of specifying that the processing for the incident or the accident is completed is detected. The completion of processing for the incident or the accident means, for example, that a suspect has been arrested or that transfer of a suspect has been completed. Alternatively, removal of an object damaged by an accident is completed. The process for the incident or the accident may be identified as being completed by the last interview conducted before the suspect is indicted. Such an event that can be identified as completion of processing for the incident or the accident is, for example, a case where a term such as “arrest”, “securing”, “completion”, or “resolution” is extracted together with a term related to the incident or the accident from a voice. Alternatively, it is a case where it is detected from the video that the handling of the affair has been completed. Completion of handling of the affair includes detection of a scene in which a suspect is secured, and detection of removal of an object damaged by the accident. According to the example illustrated in FIG. 2, at time t6, the police officer A grasps that the suspect has been secured. Accordingly, the generation unit 13 specifies that the occurrence time of the event satisfying the summary video end condition 164 is time t6. Consequently, in the video 161-1, time t6 is specified as the end time of the summary video 167.

The generation unit 13 can delete a period including an event satisfying the video deletion condition 166 (fourth condition) from the video 161 in a period from the start time to the end time of the summary video 167 specified as described above. Alternatively, after generation of the summary video 167, the video in the period satisfying the video deletion condition 166 can be deleted. The period in which the video deletion condition 166 is satisfied is, for example, a period from when an event satisfying the video deletion condition is detected until when an event satisfying the video deletion condition is no longer detected. However, in a case where an event satisfying the video embedding condition 165 is detected in a period satisfying the video deletion condition 166, the video may not be deleted from the video 161 or the summary video 167. As a result, the generation unit 13 generates the summary video 167 that does not include the period in which the video deletion condition is satisfied. However, the video deletion condition 166 is assumed to be given in advance by, for example, an administrator or the like of the video processing device 10. The video deletion condition 166 is that an event unrelated to the affair is detected. Examples thereof include a case where a period during which there is no contact with the suspect (that is, the image of the suspect is not captured in the video 161) continues for a predetermined time or longer, a case where a police officer takes a break, and a case where an investigation regarding other affairs is performed. Such an event is, for example, a case where a term such as “break” or “leaving work” is detected from a voice, or a case where a term that can be specified as an investigation related to a different affair is included is detected. The investigation related to a different affair is, for example, a case where the investigation information related to a fraud is included in the utterance in generating the summary video summarizing the affair related to the injury. In the case of the example illustrated in FIG. 2, the generation unit 13 deletes the video 161 of the period from time t2 to time t3 at which there is no contact with the suspect and the period from time t4 to time t5 from the target to be incorporated into the summary video 167. According to the video 161-3 captured by the police officer C, it is specified that a response to another incident is made after time t4. Therefore, the summary video 167 based on the video 161-3 does not include the videos after time t4.

The generation unit 13 generates the summary video 167 by extracting a portion of the video 161 satisfying the video embedding condition 165 from a video obtained by deleting a portion satisfying the video deletion condition 166 from the video 161 in a period from a start time to an end time of the summary video 167.

In the example illustrated in FIG. 2, the video 161 in the period from time t1 to time t2 includes information (such as a face image) that can identify the suspect and the victim, information indicating the escape route of the suspect, and the like, and thus satisfies the video embedding condition 165. Since the video 161 in the period from time t5 to time t6 also includes information (such as a face image) that can identify the suspect, the video embedding condition 165 is satisfied.

Therefore, as illustrated in FIG. 2, the generation unit 13 generates the summary video 167-1 obtained by extracting a period from time t1 to time t2 and a period from time t5 to time t6 from the video 161-1.

Similarly, the generation unit 13 generates the summary video 167-2 obtained by extracting a period from time t1 to time t2 and a period from time t5 to time t6 from the video 161-2. Similarly, the generation unit 13 generates the summary video 167-4 obtained by extracting a period from time t5 to time t6 from the video 161-4.

The generation unit 13 generates the summary video 167-3 obtained by extracting a period from time t1 to time t2 from the video 161-3. As illustrated in FIG. 2, since the police officer C handles another incident after time t4, there is no contact with the suspect of the current incident in the period from time t5 to time t6. That is, since the video 161-3 in the period from time t5 to time t6 satisfies the video deletion condition 166, the generation unit 13 excludes the video 161-3 in the period from time t5 to time t6 from the target to be incorporated into the summary video 167-3.

In the period from time t1 to time t2 and the period from time t5 to time t6, the generation unit 13 may determine the period to be incorporated into the summary video 167 and the period to be excluded from the target to be incorporated into the summary video 167 in units of finer (shorter) periods. For example, in the video 161 in the period from time t1 to time t2 or from time t5 to time t6, the generation unit 13 may finely exclude the portion of the video in which the suspect is not included because the suspect being tracked is temporarily lost from the target to be incorporated into the summary video 167.

The generation unit 13 may refer to the check point corresponding to the affair specified based on the type of the event acquired from the video 161. As a result of referring to the check point, in a case where the video in the period including the event corresponding to the condition listed in the check point has not been acquired from the video 161, the generation unit 13 may output a warning message. The warning message may simply notify that information is insufficient, or may notify which point of video is insufficient. In a case where the video of the period including the event corresponding to the condition listed as the check point is insufficient, the generation unit 13 may stop or not perform the generation of the summary video 167.

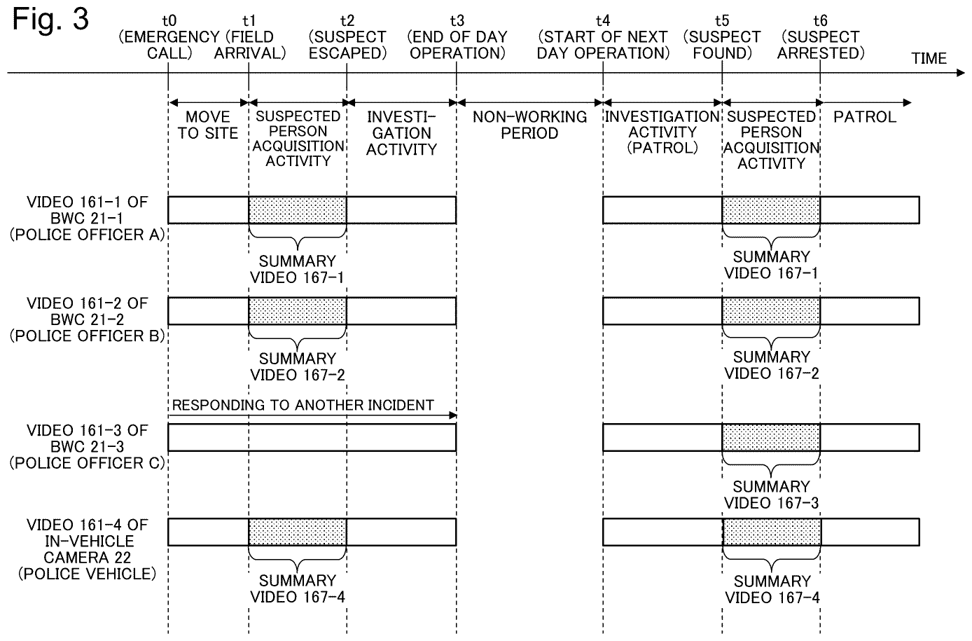

In the example illustrated in FIG. 2, the police can acquire the video 161 of when the affair has occurred. However, as in the second example illustrated in FIG. 3, for example, it is also assumed that the police goes to a scene where the affair has occurred in response to an emergency call to the police at time to. In this case, the police cannot acquire the video 161 (that is, the summary video start condition 163 is satisfied) when the affair has occurred. In this case, the generation unit 13 specifies the time (that is, time t1 at which the police arrives at the scene indicated by the event time information 162, and the like) at which the imaging related to the affair is started as the start time of the summary video 167. In the example illustrated in FIG. 3, according to the video 161-3 captured by the police officer C, it is specified that a response to another incident is made before time t3. Therefore, the summary video 167 based on the video 161-3 does not include the videos before time t3.

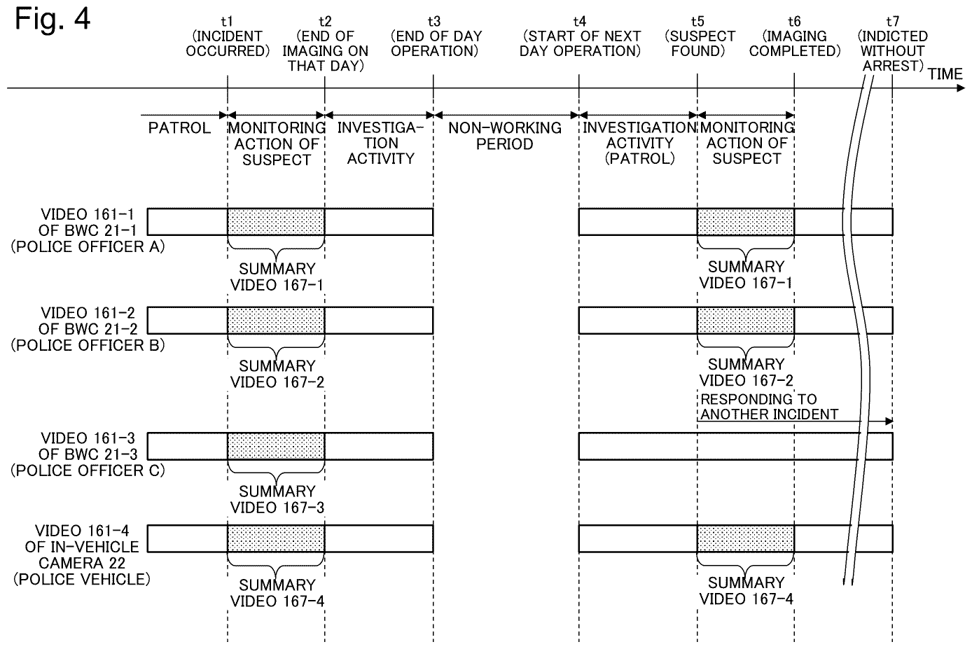

In the example illustrated in FIG. 2, the police can acquire the video 161 at the time of arresting the suspect. However, as in the third example illustrated in FIG. 4, for example, a case is also assumed in which the suspect is indicted without arrest at time t7 based on the result of monitoring the action of the suspect. In this case, since the event of arresting the suspect does not occur, the police cannot acquire the video 161 of when the suspect has been arrested. In this case, the generation unit 13 specifies, as the end time of the summary video 167, time t6 at which the capturing related to the affair indicated by the event time information 162 is ended (the capturing is ended because the video serving as sufficient evidence for indicting the suspect is obtained). In the example illustrated in FIG. 4, according to the video 161-3 captured by the police officer C, it is specified that a response to another incident is made after time t5. Therefore, the summary video 167 based on the video 161-3 does not include the videos after time t5.

The generation unit 13 may add information, which is obtained by the information acquisition unit 17 and is posted on an SNS or the like related to an affair, to the summary video 167 as additional information for complementing the summary video 167 as an evidence video.

The output unit 15 outputs the summary video 167 generated by the generation unit 13 as described above to the outside.

FIG. 3 is a diagram illustrating a mode in which the output unit 15 according to the present example embodiment displays the summary video 167 on the terminal device 23 in the case of the example illustrated in FIG. 2. For example, as illustrated in FIG. 3, the output unit 15 displays the summary videos 167-1 to 167-4 in four display regions on the display screen of the terminal device 23. In the example illustrated in FIG. 3, one evidence video (third summary video) obtained by integrating four videos is displayed on the display screen of the terminal device 23, but the number of videos to be integrated is not limited thereto. For example, in a case where there is only one BWC 21 that captures an image of a certain affair, an evidence video based on one the summary video 167 is generated. Similarly, in a case where there are two BWCs 21 obtained by imaging a certain affair, an evidence video obtained by integrating summary videos obtained by the BWCs 21 is generated. In the evidence video, a position at which each the summary video 167 is displayed may be determined based on a predetermined condition. As such a predetermined condition, for example, the identification information of each camera is arranged in ascending or descending order based on the identification information of the BWC 21 or the identification information of the in-vehicle camera 22. In addition, the display position may be changed according to the content of the summary video 167. For example, focusing on the length of the video, the summary video for 10 minutes may be displayed at a more conspicuous position than the summary video for 5 minutes. Alternatively, focusing on the event included in the video, the summary video 167 including more events satisfying the video embedding condition 165 may be displayed at a conspicuous position. The conspicuous position is, for example, the center of the screen on the display screen. Alternatively, information for specifying a conspicuous position may be received in advance, and the position may be specified according to the received information.

The generation unit 13 may generate evidence videos that display the individual summary videos 167-1 to 167-4 in time series in synchronization with each other. As a result, the output unit 15 can display the individual summary videos 167-1 to 167-4 on the display screen of the terminal device 23 in synchronization with each other in time series. That is, the evidence video displayed on the display screen of the terminal device 23 includes the summary videos 167-1 to 167-4 in which a certain imaging target (for example, a suspect or the like) is imaged from different directions at a certain time t. The evidence video in which the summary videos 167 are synchronized in this manner may include a period in which some summary videos are not displayed. For example, in the evidence video obtained by synchronously integrating the summary videos 167-1 to 167-4 illustrated in FIG. 2, the summary video 167-3 is not displayed in the period from time t5 to time t6. In a case where there is a period in which a part of the summary video 167 is not displayed in the evidence video, the display region for displaying another summary video may be temporarily enlarged. In the example of FIG. 2, when the period from time t5 to time t6 is displayed, the display regions of the summary video 167-1, the summary video 167-2, and the summary video 167-4 are made larger than those in other periods.

The generation unit 13 may perform three-dimensional processing on the video 161 from the video 161 obtained by imaging a certain imaging target from a plurality of different directions using an existing image processing technology, and generate the summary video 167 including the processing result.

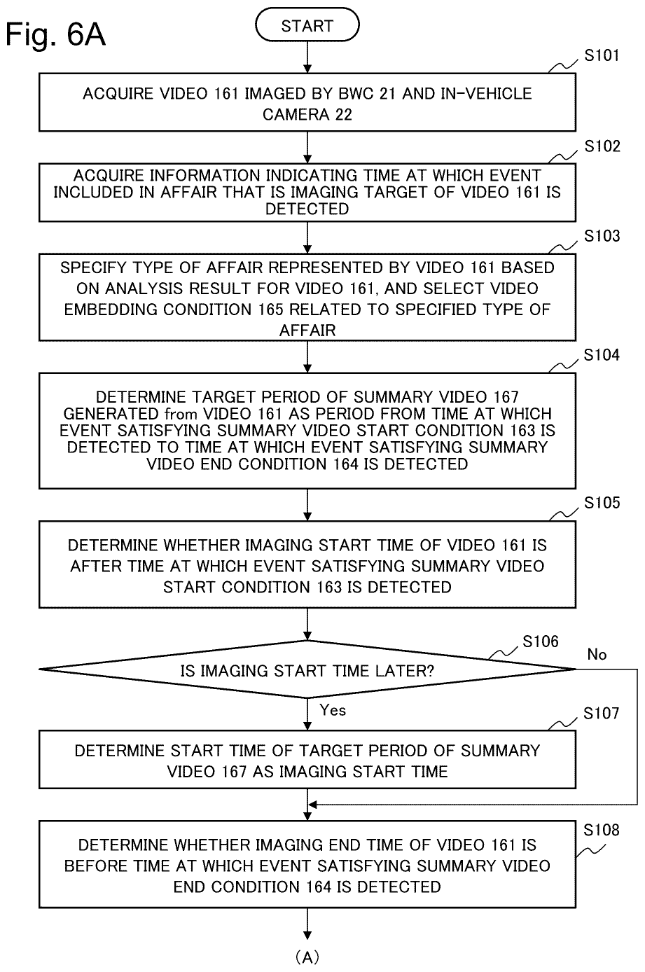

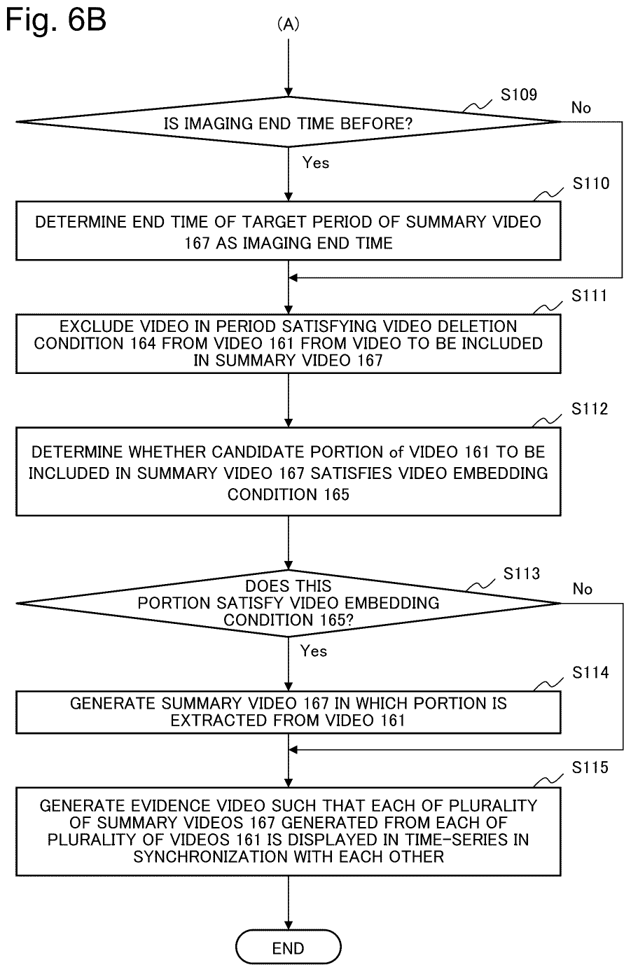

Next, an operation (processing) of the video processing device 10 according to the present example embodiment will be described in detail with reference to flowcharts of FIGS. 6A and 6B.

The video acquisition unit 11 acquires the video 161 captured regarding a certain affair by the BWC 21 and the in-vehicle camera 22 via a communication line or via a recording medium storing the video 161 (step S101). The event information acquisition unit 12 acquires information indicating the time at which an event included in an affair that is an imaging target of the video 161 is detected from the outside or by performing analysis processing on the video 161 (step S102).

The affair identification unit 18 specifies the type of the affair represented by the video 161 based on the analysis result for the video 161 by the event information acquisition unit 12, and the identification unit 14 selects the video embedding condition 165 regarding the type of the specified affair (step S103). The generation unit 13 determines the target period of the summary video 167 generated from the video 161 as a period from the time when the event satisfying the summary video start condition 163 is detected to the time when the event satisfying the summary video end condition 164 is detected (step S104).

The generation unit 13 determines whether the imaging start time of the video 161 is later than the time at which the event satisfying the summary video start condition 163 is detected (step S105). In a case where the imaging start time of the video 161 is later (Yes in step S106), the generation unit 13 determines the start time of the target period of the summary video 167 as the imaging start time related to the affair (step S107). In a case where the imaging start time of the video 161 is not later (that is, the imaging start time of the video 161 is earlier) (No in step S106), the process proceeds to step S108.

The generation unit 13 determines whether the imaging end time of the video 161 is earlier than the time at which the event satisfying the summary video end condition 164 is detected (step S108). In a case where the imaging end time of the video 161 is earlier (Yes in step S109), the generation unit 13 determines the end time of the target period of the summary video 167 as the imaging end time (step S110). In a case where the imaging end time of the video 161 is not earlier (that is, the imaging start time of the video 161 is later) (No in step S109), the process proceeds to step S111.

The generation unit 13 determines whether a portion, which is a candidate for a target to be included in the summary video 167, of the video 161 satisfies the video embedding condition 165 (step S112). In a case where the portion satisfies the video embedding condition 165 (Yes in step S113), the generation unit 13 generates the summary video 167 obtained by extracting the portion from the video 161 (step S114). In a case where the portion satisfies the video embedding condition 165 (No in step S113), the processing proceeds to step S115.

The generation unit 13 generates the evidence video such that each of the plurality of summary videos 167 generated from each of the plurality of videos 161 is displayed in synchronization with each other in time series (step S115), and the entire processing ends.

The video processing device 10 according to the present example embodiment can generate a summary video including an appropriate period. This is because the video processing device 10 generates the summary video 167 including a period from the time when the event satisfying the summary video start condition 163 is detected to the time when the event satisfying the summary video end condition 164 is detected, based on the event time information 162 related to the affair.

Hereinafter, effects achieved by the video processing device 10 according to the present example embodiment will be described in detail.

The video processing device 10 according to the present example embodiment acquires the video 161 related to an affair which is a target for generating the summary video 167 and the event time information 162 indicating the time when the event related to the affair is detected. The video processing device 10 sets the time at which the event satisfying the summary video start condition 163 is detected as the start time of the summary video 167, and sets the time at which the event satisfying the summary video end condition 164 is detected as the end time of the summary video 167. Then, the video processing device 10 automatically generates the summary video 167 of the video 161 in the period from the set start time to the end time. Consequently, in creating the summary video 167, the video processing device 10 can appropriately and efficiently extract the video in the period used as the summary video 167 from the video used as the original data.

The video processing device 10 according to the present example embodiment specifies the time at which the event related to the affair is detected based on at least one of the information related to the sound and the information related to the movement of the object related to the affair for which the summary video 167 is to be generated. Consequently, the video processing device 10 can efficiently generate the summary video 167.

The video processing device 10 according to the present example embodiment specifies the type of the affair represented by the video 161, and specifies the video embedding condition 165 regarding the type of the specified affair. Then, in a case where a portion included in the video 161 satisfies the video embedding condition 165, the video processing device 10 sets the portion as a target to be included in the summary video 167. Thus, the video processing device 10 can appropriately generate the summary video 167 for various types of affairs.

In a case where the video 161 is a video in which imaging related to an affair is started from a time later than the time at which an event satisfying the summary video start condition 163 is detected, the video processing device 10 according to the present example embodiment sets the time at which imaging of the video 161 related to the affair is started as the start time of the summary video 167. Then, in a case where the video 161 is a video in which imaging related to an affair is ended at a time before the time at which an event satisfying the summary video end condition 164 is detected, the video processing device 10 sets the time at which the imaging of the video 161 related to the affair is ended as the end time of the summary video 167. As a result, even in a case where the video 161 that satisfies the summary video start condition 163 and/or the summary video end condition 164 cannot be acquired, the video processing device 10 can appropriately generate the summary video 167.

In a case where a plurality of videos 161 related to an affair have been obtained, the video processing device 10 according to the present example embodiment generates individual summary videos 167 generated from the individual videos 161 so as to be capable of being displayed in synchronization with each other in time series. Thus, for example, since the video processing device 10 generates the summary video 167 obtained by imaging a certain scene from a plurality of imaging directions, it is possible to provide the summary video 167 which is easy to understand as an evidence video.

The video processing device 10 according to the present example embodiment generates the summary video 167 by deleting the video of the period satisfying the video deletion condition 166 from the video 161.

Consequently, the video processing device 10 can appropriately generate the summary video 167 so as not to include unnecessary videos as an evidence video.

The video processing device 10 according to the present example embodiment may set, for example, an assault (excessive defense) incident against a suspect by a police officer as a generation target of the summary video 167. In this case, since the type of the target affair is an assault incident, the identification unit 14 specifies the video embedding condition 165 regarding the assault incident. Then, the event information acquisition unit 12 analyzes the video 161 in which the act of assault on the suspect by the police officer is imaged. The generation unit 13 is only required to generate the summary video 167 serving as evidence necessary for indicting a police officer who has committed an act of assault on a suspect in the same procedure as described above. In this case, the event information acquisition unit 12 may determine whether an act of assault on the suspect by the police officer corresponds to excessive defense using, for example, AI learned about the relationship between the analysis result of the video 161 and the presence or absence of an act corresponding to excessive defense indicated by the video 161, and generate the event time information 162 indicating the time when the act corresponding to excessive defense has been detected.

The video processing device 10 according to the present example embodiment may have a function of checking whether tampering has not been performed, for example, replacement of a face image, editing of a voice, or the like, with respect to the acquired video 161. In this case, the video processing device 10 may use, for example, an existing image recognition technology capable of determining presence or absence of tampering with the video. Alternatively, the video processing device 10 may detect, using AI or the like, whether there is a contradiction regarding the occurrence situation of the time-series events obtained from the analysis result for the video 161. For example, in a case where a thing or a person existing at a certain place at a certain time is present at another time and place that are temporally immovable in the video 161, the video processing device 10 detects that tampering with the video 161 has been performed.

The video processing device 10 according to the present example embodiment described above generates a summary video used for a suit or the like regarding an affair handled by the police, but can also be used as a device that generates a summary video necessary for an insurance company to recognize an accident or the like. In this case, the video acquisition unit 11 acquires, for example, the video 161 captured by a drive recorder of the vehicle in which the accident has occurred and the vehicle traveling in the vicinity of the vehicle at the time of the accident, and the video 161 captured by a monitoring camera installed in the vicinity of the accident site. Then, the video processing device 10 may generate the summary video 167 based on the acquired video 161 in the same manner as described above.

### Second Example Embodiment

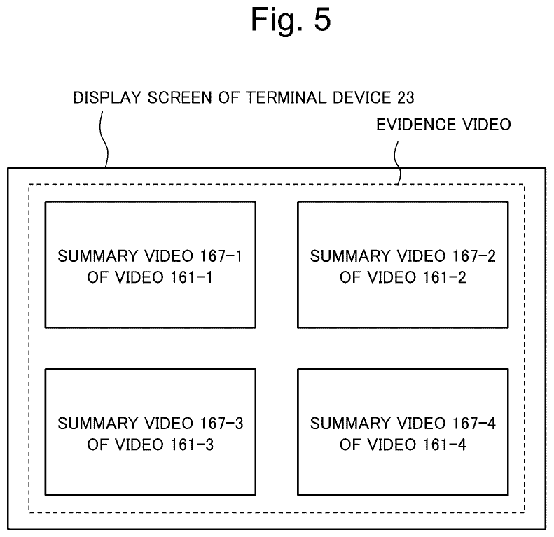

FIG. 5 is a block diagram illustrating a configuration of a video processing device 30 according to a second example embodiment of the present invention.

The video processing device 30 according to the present example embodiment includes a video acquisition unit 31, an event information acquisition unit 32, and a generation unit 33. The video acquisition unit 31, the event information acquisition unit 32, and the generation unit 33 are, in order, a video acquisition means, an event information acquisition means, and a generation means as an example.

The video acquisition unit 31 acquires a video 310 (first video). The video 310 is, for example, information similar to that of the video 161 according to the first example embodiment. For example, the video acquisition unit 31 operates similarly to the video acquisition unit 11 according to the first example embodiment.

The event information acquisition unit 32 acquires information 320 indicating the time when the event has been detected. The information 320 indicating the time when the event has been detected is, for example, information similar to the event time information 162 according to the first example embodiment. The event information acquisition unit 32 operates similarly to the event information acquisition unit 12 according to the first example embodiment, for example.

The generation unit 33 generates a summary video 333 (first summary video) including a period from the time at which the event satisfying a first condition 331 is detected to the time at which the event satisfying a second condition 332 is detected based on the video 310 and information 320 indicating the time at which the event is detected. The first condition 331 is, for example, a condition similar to the summary video start condition 163 according to the first example embodiment. The second condition 332 is, for example, a condition similar to the summary video end condition 164 according to the first example embodiment. The summary video 333 is, for example, a video similar to the summary video 167 according to the first example embodiment. The generation unit 33 operates similarly to the generation unit 13 according to the first example embodiment, for example.

Next, an operation (processing) of the video processing device 30 according to the present example embodiment will be described in detail with reference to a flowchart of FIG. 6.

The video acquisition unit 31 acquires the video 310 (step S201). The event information acquisition unit 32 acquires the information 320 indicating the time when the event has been detected (step S202).

Based on the video 310 and the information 320 indicating the time when the event is detected, the generation unit 33 generates the summary video 333 indicating at least a part of the video 310 including a period from the time when the event satisfying the first condition 331 is detected to the time when the event satisfying the second condition 332 is detected (step S203), and the entire processing ends.

The video processing device 30 according to the present example embodiment can generate a summary video including an appropriate period. This is because the video processing device 30 generates the summary video 333 including a period from the time when the event satisfying the first condition 331 is detected to the time when the event satisfying the second condition 332 is detected, based on the information 320 indicating the time when the event related to the affair is detected.

### Hardware Configuration Example

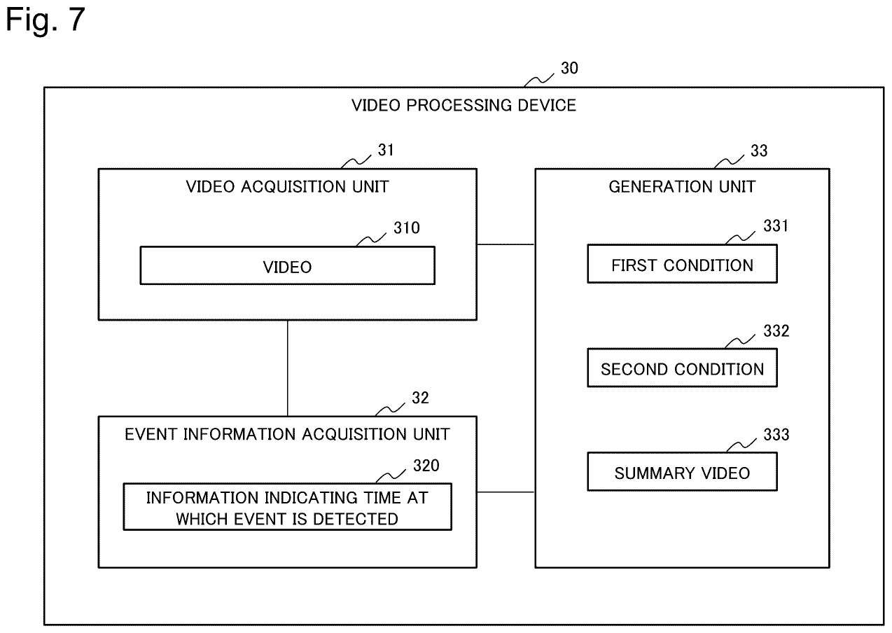

Each unit in the video processing device illustrated in FIG. 1 and in each of the above-described example embodiments can be realized by dedicated hardware (HW) (electronic circuit). In addition, in FIGS. 1 and 7, at least the following configuration can be regarded as a function (processing) unit (software module) of a software program including an instruction executed by a processor.
Video acquisition units 11 and 31,
Event information acquisition units 12 and 32,
Generation units 13 and 33,
Identification unit 14,
Output unit 15,
Storage control function in the storage unit 16,
Information acquisition unit 17, and
Affair identification unit 18.

However, the division of each unit illustrated in these drawings is configuration for convenience of description, and various configurations can be assumed at the time of implementation. An example of a hardware environment in this case will be described with reference to FIG. 9.

FIG. 9 is a diagram exemplarily describing a configuration of an information processing device 900 (computer) capable of realizing the video processing device according to each example embodiment of the present invention. That is, FIG. 9 is a configuration of a computer (information processing device) capable of realizing the video processing device illustrated in FIGS. 1 and 7, and represents a hardware environment capable of realizing each function in the above-described example embodiments. The information processing device 900 illustrated in FIG. 9 includes the following components as constituent elements.
CPU (Central_Processing_Unit) 901,
ROM (Read_Only_Memory) 902,
RAM (Random_Access_Memory) 903,
Hard disk (storage device) 904,
Communication interface 905,
Bus 906 (communication line),
Reader/writer 908 capable of reading and writing data stored in a recording medium 907 such as a CD-ROM (Compact_Disc_Read_Only_Memory), and
Input/output interface 909 such as a monitor, a speaker, or a keyboard.

That is, the information processing device 900 including the above-described components is a general computer to which these components are connected via the bus 906. The information processing device 900 may include a plurality of the CPUs 901 or may include a CPU 901 configured by multiple cores.

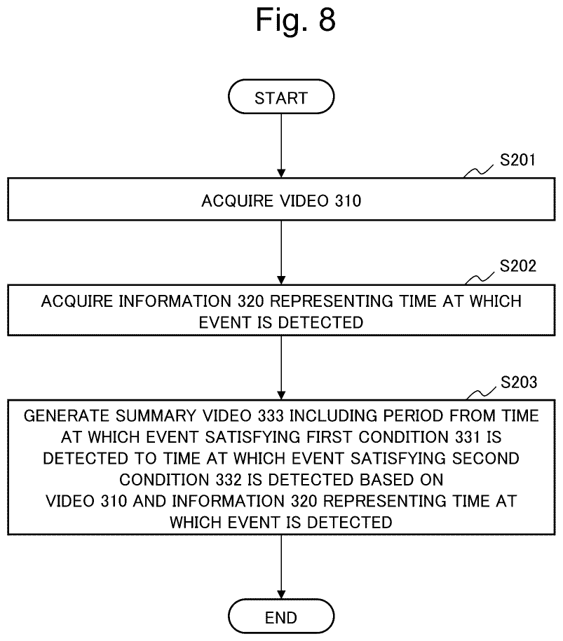

In the present invention described using the above-described example embodiment as an example, a computer program capable of realizing the following functions is supplied to the information processing device 900 illustrated in FIG. 7. The function is the above-described configuration in the block configuration diagram (FIGS. 1 and 7) referred to in the description of the example embodiment or the function of the flowchart (FIGS. 6A, 6B, and 8). Thereafter, the present invention is achieved by reading the computer program to the CPU 901 of the hardware and interpreting and executing the computer program. The computer program supplied into the device may be stored in a readable/writable volatile memory (RAM 903) or a nonvolatile storage device such as the ROM 902 or the hard disk 904.

In the above case, a general procedure can be adopted at present as a method of supplying the computer program into the hardware. Examples of the procedure include a method of installing the program in the device via various recording media 907 such as a CD-ROM, a method of downloading the program from the outside via a communication line such as the Internet, and the like. In such a case, the present invention can be understood to be constituted by a code constituting the computer program or the recording medium 907 storing the code.

The present invention has been described above using the above-described example embodiments as exemplary examples. However, the present invention is not limited to the above-described example embodiments. That is, the present invention can apply various aspects that can be understood by those skilled in the art within the scope of the present invention.

This application is based upon and claims the benefit of priority from Japanese Patent Application No. 2023-012299, filed on Jan. 30, 2023, the disclosure of which is incorporated herein in its entirety by reference.

### REFERENCE SIGNS LIST

1 video processing system
10 video processing device
11 video acquisition unit
12 event information acquisition unit
13 generation unit
14 identification unit
15 output unit
16 storage unit
17 information acquisition unit
18 affair identification unit
161 video
162 event time information
163 summary video start condition
164 summary video end condition
165 video embedding condition
166 video deletion condition
167 summary video
21 BWC
22 in-vehicle camera
23 terminal device
30 video processing device
31 video acquisition unit
32 event information acquisition unit
320 INFORMATION INDICATING TIME AT WHICH EVENT IS DETECTED
33 generation unit
331 first condition
332 second condition
333 summary video
900 information processing device
901 CPU
902 ROM
903 RAM
904 hard disk (storage device)
905 communication interface
906 bus
907 recording medium
908 reader/writer
909 input/output interface

What is claimed is:

1. A video processing device comprising:
a memory storing instructions; and
a processor connected to the memory and configured to execute the instructions to:
acquire a first video;
acquire information indicating a time at which an event is detected; and
generate, based on the first video and information indicating a time at which the event is detected, a first summary video including a period from a time at which an event satisfying a first condition is detected to a time at which an event satisfying a second condition is detected.

2. The video processing device according to claim 1, wherein
the processor is configured to execute the instructions to
specify a time at which the event is detected based on at least one of information regarding a sound or information regarding a movement of an object.

3. The video processing device according to claim 1, wherein
the processor is configured to execute the instructions to
specify a type of an affair based on the first video; and
specify a third condition based on a type of the affair.

4. The video processing device according to claim 3, wherein
the processor is configured to execute the instructions to
generate the first summary video when an event satisfying the third condition is detected in the first video.

5. The video processing device according to claim 1, wherein
in a case where the first video is a video in which imaging is started from a time later than a time at which the event satisfying the first condition is detected,
the processor is configured to execute the instructions to
generate the first summary video including a period from a time at which imaging of the first video is started to a time at which the event satisfying the second condition is detected.

6. The video processing device according to claim 1, wherein
in a case where the first video is a video in which imaging is ended at a time before a time at which the event satisfying the second condition is detected,
the processor is configured to execute the instructions to
the generation means is configured to generate the first summary video including a period from a time at which the event satisfying the first condition is detected to a time at which imaging of the first video is ended.

7. The video processing device according to claim 1, wherein
the processor is configured to execute the instructions to
acquire a second video; and
generate a second summary video including a period from a time at which an event satisfying the first condition is detected to a time at which an event satisfying the second condition is detected based on the second video and information indicating a time at which the event is detected; and
generate a third summary video including the first summary video and the second summary video.

8. The video processing device according to claim 1, wherein
the processor is configured to execute the instructions to
generate the first summary video by deleting a video of a period satisfying a fourth condition from the first video.

9. A video processing method for causing an information processing device to execute:
acquiring a first video;
acquiring information indicating a time at which an event is detected; and
generating a first summary video including a period from a time at which an event satisfying a first condition is detected to a time at which an event satisfying a second condition is detected based on the first video and information indicating a time at which the event is detected.

10. A recording medium having stored therein a video processing program for causing a computer to execute:
a video acquisition process of acquiring a first video;
a time acquisition process of acquiring information indicating a time at which an event is detected; and
a generation process of generating, based on the first video and information indicating a time at which the event is detected, a first summary video including a period from a time at which an event satisfying a first condition is detected to a time at which an event satisfying a second condition is detected.
